(19) United States
(12) Patent Application Publication
(10) Pub. No.: US 2019/0171213 A1
(43) Pub. Date: Jun. 6, 2019

(54) Autonomous driving system based on electronic map and electronic compass

(71) Applicant: Houbing LUO, Jiangsu (CN)

(72) Inventor: Houbing LUO, Jiangsu (CN)

(21) Appl. No.: 16/323,554

(22) PCT Filed: Jun. 5, 2017
(86) PCT No.: PCT/CN2017/087202

§ 371 Date: Feb. 6, 2019

(30) Foreign Application Priority Data
Aug. 7, 2016 (CN) 201610637110.8

(51) Int. Cl. G05D 1/02; G05D 1/00

(52) U.S. Cl. CPC G05D 1/0212; G05D 1/0088

(57) ABSTRACT

An autonomous driving system has an information processor configured to process information based on an electronic map and a digital compass and to program a vehicle. The autonomous driving system enables cruise, braking at the curves and lane changing thereof, by generating control information for a steering control system, a brake control system and an engine control system in the vehicle, based on input information about a destination, the electronic map calculates the most reasonable path by taking into account the total path length, the number of curves and radii of the curves, moreover, vehicle location information from a navigation system in the vehicle and vehicle orientation information from the digital compass are processed, at the same time, an inter-vehicular local area network (LAN) is established between vehicles.

### CROSS REFERENCE TO RELATED APPLICATION

This patent application claims priority to PCT/CN2017/087202, filed Jun. 5, 2017, and Chinese patent application 201610637110.8, filed Aug. 7, 2016, which are both hereby incorporated by reference in their entirety.

### TECHNICAL FIELD

The present invention relates to an autonomous driving system and, in particular, to an autonomous driving system based on an electronic map and a digital or electronic compass, and pertains to the field of autonomous vehicle driving.

### BACKGROUND

Autonomous driving, also known as driverless driving or computer-based driving, is a self-driving technology based on computer systems. The development and research of self-driving cars has kicked off since the 1970s and now seems approaching the stage of practical application. For example, an autonomous car has been granted the first self-driving car license in the U. S. in May 2012.

Existing self-driving cars rely on the collaboration of artificial intelligence, visual computing, radars, monitoring devices and a global positioning system for allowing for a computer to automatically and safely manipulate the motor vehicle, without any active human operation, based on surrounding traffic conditions detected by video cameras, radar sensors and laser range finders, and to navigate the road ahead based on a detailed map (created beforehand from data collected by cars driven by human drivers). How to achieve accurate, high-precision cruise by autonomous driving systems is the core concern regarding safe operation of self-driving cars. At present, according to the regulations of the Nevada Motor Vehicle Administration in the U.S., there must be two persons in a running self-driving car, one of whom sits in front of the steering wheel, and the other checks the driving path, road surface conditions and traffic signals, displayed on a computer monitor screen. Once any abnormal event occurs, the driver must instantly switch to the manual mode in order to avoid car from getting into a safety accident. Therefore, it will be of great significance and value for self-driving vehicles to develop an autonomous driving system enabling accurate, high-precision cruise.

### SUMMARY OF THE DISCLOSURE

In view of the above problems and need in the prior art, it is an object of the present invention to provide an autonomous driving system based on an electronic map and a digital compass, which allows accurate, high-precision cruise of a self-driving vehicle.

In order to achieve this object, the subject matter of the present invention is as follows:

With similarity to the control exerted by a computer numerical control (CNC) system on a lathe, current vehicles are all equipped with navigation and positioning functions as well as radar systems. Moreover, existing electronic maps are all able to provide detailed road information. The present invention is just based on these two facts to provide an autonomous driving system based on an electronic map and a digital compass. Specifically, the subject matter of the present invention lies in:

An autonomous driving system based on an electronic map and a digital compass, characterized in comprising the electronic map and the digital compass, which are configured to program a vehicle, that is, the said autonomous driving system enables cruise, braking at the curves and lane changing thereof, by generating control information for a steering control system, a brake control system and an engine control system in the vehicle, based on input information about a destination, the electronic map calculates the most reasonable path by taking into account the total path length, the number of curves and radii of the curves, moreover, vehicle location information from a navigation system in the vehicle and vehicle orientation information from the digital compass are processed, at the same time, an inter-vehicular local area network (LAN) is established between vehicles.

Different from typical LANs, the term “inter-vehicular LAN” as used herein is meant to refer to a LAN in which the autonomous driving systems in the vehicles can share among one another information about the speeds, paths, path changes and relative positions of the vehicles.

In a preferred embodiment, the autonomous driving system may share its position information with electronic maps in mobile phones in order to identify pedestrians. The inter-vehicular LAN may cover a range of 100 meters. This embodiment is advantageous in active detectability of pedestrian obstacles.

The present invention also provides an autonomous driving system for a bus, characterized in allowing payments and bus status inquiries based on electronic maps both in mobile phones and in the vehicle.

The autonomous driving system of the present invention can provide the accurate driving status of the vehicle by processing information received from surrounding vehicles, positional information from electronic maps and obstacle information obtained by radars in the vehicle.

The radars function just like a tool offset in a CNC system to adjust the vehicle in real time when there is no electronic map-equipped obstacle is found. The electronic map can also allow remote early warning about road congestion. Based on such early warning information about road congestion, the autonomous driving system of the present invention can automatically plan a new path. Such an advantage is based on interactions established between the vehicles. When any of the vehicles starts to operate in an abnormal condition, an early warning alert can be immediately given to all the other vehicles within the coverage of the inter-vehicular LAN. Upon receiving the alert, the autonomous driving systems in these vehicles can instruct them to brake on time, thus preventing possible safety accidents and ensuring safe driverless driving.

### BRIEF DESCRIPTION OF THE DRAWINGS

FIG. 1 is a schematic diagram illustrating how an autonomous driving system based on an electronic map and a digital compass, according to the present invention operates.

### DETAILED DESCRIPTION

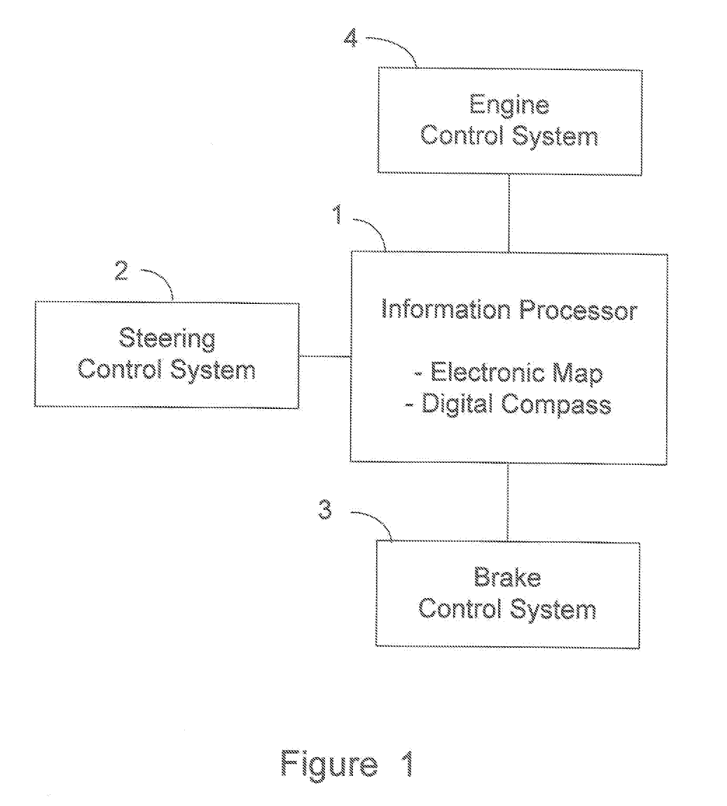

As shown in FIG. 1, the principle of an autonomous driving system based on an electronic map and a digital compass according to the present invention is as follows:

Based on input information about a destination, the electronic map calculates the most reasonable path by taking into account the total path length, the number of curves and radii of the curves, moreover, vehicle location information from a navigation system in the vehicle and vehicle orientation information from the digital compass are processed. Through the information processing by the electronic map and the digital compass in an information processor 1, the autonomous driving system enables cruise, braking at the curves and lane changing thereof, by generating control information for a steering control system 2, a brake control system 3 and an engine control system 4 in the vehicle.

The autonomous driving system of the present invention can be more effectively used in an extended-range hybrid power system. In this case, comprehensive information from the electronic map enables the most economical power combination and energy recovery. The above three systems function like a servo system in a CNC system and constitute part of driving.

The electronic map also allows interactions of the vehicle with other vehicles. This requires the establishment of an inter-vehicular local area network (LAN) among these vehicles by their individual electronic maps. Different from typical LANs, the term “inter-vehicular LAN” as used herein is intended to mean a LAN in which the autonomous driving systems in the vehicles can share among one another information about the speeds, paths, path changes and relative positions of the vehicles. The autonomous driving system may share its position information with electronic maps in mobile phones in order to identify pedestrians, and the inter-vehicular LAN may cover a range of 100 meters. This embodiment is advantageous in allowing active detection of pedestrian obstacles. The autonomous driving system of the present invention can provide the accurate driving status of the vehicle by processing information received from surrounding vehicles, positional information from electronic maps and information about obstacles detected by radars equipped in the vehicle. The radars function just like a tool offset in a CNC system to adjust the vehicle in real time when there is no electronic map-equipped obstacle is found. The electronic maps can also allow remote early warning about road congestion. Based on such early warning information about road congestion, the autonomous driving system can automatically plan a new path. This solution is advantageous over conventional autonomous driving solutions based on radars equipped in vehicles in higher comprehensiveness because interactions can be established between the individual vehicles. When any of the vehicles starts to operate in an abnormal condition, an early warning alert can be immediately given to all the other vehicles covered by the inter-vehicular LAN. Upon receiving the alert, the autonomous driving systems in these vehicles can instruct them to brake on time, thereby preventing possible safety accidents and ensuring safe self-driving.

When used in a bus, the electronic map and digital compass-based autonomous driving system allows automatic payments and bus status inquiries based on networking functions of the electronic maps both in mobile phones and in the vehicle.

Lastly, it is to be noted herein that the foregoing embodiments are presented merely for the purpose of explaining the subject matter of the present invention in greater detail and shall not be construed as limiting the scope of the present invention in any sense. Any and all non-substantive modifications and adjustments made by those skilled in the art based on the teachings hereinabove are considered to fall within the scope of the invention.

What is claimed is:

1. An autonomous driving system based on an electronic map and a digital compass, characterized in comprising the electronic map and the digital compass, which are configured to program a vehicle, that is, the said autonomous driving system enables cruise, braking at the curves and lane changing thereof, by generating control information for a steering control system, a brake control system and an engine control system in the vehicle, based on input information about a destination, the electronic map calculates the most reasonable path by taking into account the total path length, the number of curves and radii of the curves, moreover, vehicle location information from a navigation system in the vehicle and vehicle orientation information from the digital compass are processed, at the same time, an inter-vehicular local area network (LAN) is established between vehicles.

2. An autonomous driving system according to claim 1, characterized in the said autonomous driving system shares its position information with electronic maps in mobile phones.

3. An autonomous driving system for a bus, characterized in allowing payments and bus status inquiries based on electronic maps both in mobile phones and in the vehicle.
